(19) United States
(12) Patent Application Publication
(10) Pub. No.: US 2026/0036327 A1
(43) Pub. Date: Feb. 5, 2026

(54) WINDOW KIT OF AN AIR CONDITIONER

(71) Applicant: LG ELECTRONICS INC., Seoul (KR)

(72) Inventors: Changhoon JEONG, Seoul (KR); Hyuncheol PARK, Seoul (KR)

(73) Assignee: LG ELECTRONICS INC., Seoul (KR)

(21) Appl. No.: 19/089,751

(22) Filed: Mar. 25, 2025

Related U.S. Application Data
(63) Continuation of application No. PCT/KR2024/015558, filed on Oct. 15, 2024.

(30) Foreign Application Priority Data
Aug. 2, 2024 (KR) 10-2024-0103325

(51) Int. Cl. F24F 13/02; F24F 1/031; F24F 1/04

(52) U.S. Cl. CPC F24F 13/0254; F24F 1/031; F24F 1/04; F24F 2221/20

(57) ABSTRACT

A window kit configured to connect a mobile air conditioner to a window frame to which a window is connected, the window having a first end hingedly attached to the window frame, a second end located opposite to the first end, and a first side and a second side each extending between the first end and the second end, the window kit including a side member configured to be disposed between the window frame and the first side of the window; and a base member configured to be disposed between the window frame and the second end of the window, the base member including an opening configured to accommodate a nozzle extending from an exhaust port of the mobile air conditioner, a first end of the base member being configured to be coupled to the side member.

### CROSS-REFERENCE TO RELATED APPLICATIONS

The present application is a continuation application of PCT International Application No. PCT/KR2024/015558, filed on Oct. 15, 2024, which claims priority under 35 U.S.C. § 119(a) to Patent Application No. 10-2024-0103325, filed in the Republic of Korea on Aug. 2, 2024, all of which are hereby expressly incorporated by reference into the present application.

### BACKGROUND

The present disclosure relates to a window kit for an air conditioner capable of fixing an exhaust guide member of a mobile air conditioner to a window.

In general, an air conditioner is a cooling/heating system that cools or heats a room by repeatedly suctioning in indoor air, exchanging heat with a low-temperature or high-temperature refrigerant, and then discharging it into the room and includes of a series of cycles using a compressor, an outdoor heat exchanger, an expansion valve, and an evaporator.

Air conditioners may be composed of split-type air conditioners in which the indoor and outdoor devices are separated, and integrated air conditioners in which the indoor and outdoor devices are coupled.

The split-type air conditioner is mainly composed of an outdoor device (also referred to as an ‘outdoor side’ or ‘heat radiation side’) installed outdoors and an indoor device (also referred to as an ‘indoor side’ or ‘heat absorption side’) installed mainly inside a building and an outdoor heat exchanger and a compressor are installed in the outdoor device, and an evaporator is installed in the indoor device.

The above-mentioned integrated air conditioner is a combined indoor and outdoor device, and the indoor heat exchanger and outdoor heat exchanger are provided in one main body, so that the entire air conditioner components are installed in one main body.

The integrated air conditioner may be classified into a fixed air conditioner that is fixedly installed on a window or the like, and a mobile air conditioner whose main body can be moved to a required space and which discharges heat-exchanged air to the outside through an exhaust guide member.

Among these, the mobile air conditioner may be configured such that the exhaust guide member is fixed to a window to discharge the heat-exchanged air to the outside. A window kit for fixing the exhaust guide member of the mobile air conditioner may be provided on the window.

### SUMMARY

An object of an embodiment of the present disclosure is to provide a window kit capable of stably fixing an exhaust guide member of a mobile air conditioner to a hinged window assembly.

An object of an embodiment of the present disclosure is to provide a window kit for fixing an exhaust guide member of a mobile air conditioner, which is adjustable in shape and size so that it can be universally installed in window assemblies of various sizes.

An object of an embodiment of the present disclosure is to provide a window kit that can prevent air discharged to the outside through an exhaust guide member from being re-introduced into a room or cold air inside a room from being leaked outside by minimizing an open area in a window assembly to which an exhaust guide member of a mobile air conditioner is fixed.

An object of an embodiment of the present disclosure is to provide a window kit for fixing an exhaust guide member of a mobile air conditioner, which can be easily installed in a window assembly.

An object of an embodiment of the present disclosure is to provide a window kit for fixing an exhaust guide member of a mobile air conditioner, which can be fixed without damaging a window assembly.

According to one embodiment to solve the above problem, a window kit of an air conditioner is mounted on a window frame to which a hinged window is connected and is coupled with an exhaust guide member extending from an exhaust port of a mobile air conditioner, and includes a base member which is mounted between a rotation end part of the hinged window and the window frame and which includes an insertion hole or opening into which a nozzle of the exhaust guide member is inserted; and a side member which is mounted between a side end part intersecting the rotation end part of the hinged window and the window frame, in which at least one end part of the base member is mounted by being partially inserted into the side member.

The base member may include a plurality of panels connected to be mutually pulled in and out, so as to have a variable length. Namely, the plurality of panels are slidably connected to each other to adjust a length of the base member.

The side member may include a front part or front portion disposed on one surface of the window frame, a side part or side portion formed by bending from the front part and disposed between the window frame and the side end part of the hinged window, and a coupling part or coupling portion formed on one surface of the side part and having a coupling groove into which the one end part of the base member is inserted.

The one end part of the base member may be inserted into the coupling groove.

A fastening member may extend through the coupling portion into the one end part of the base member to fix the base member to the side member.

The coupling part may be formed on the other end part of the side part, and one end part of the front part may be formed to protrude to one side more than one end part of the side part.

The side member may includes a plurality of separable unit members, so as to have a variable shape, and the unit members may include a plurality of first unit front parts included in the front part, and a plurality of unit side parts included in the side part. That is, a shape of the side member may be adjusted by removing one or more of the separable unit members to fit a space between the second frame member and the first side of the window.

The side member may include a cut part or cut portion disposed between respective unit members for separation of the unit member, the cut part may include a first cut line formed on the front part and disposed between the plurality of first unit front parts, a second cut line formed on the side part and disposed between the plurality of unit side parts, and a third cut line formed between the front part and the side part and connecting the first cut line and the second cut line.

The first cut line may be formed as an open hole, and the second cut line may be formed as a recessed groove.

A fourth cut line intersecting the first cut line may be formed on the front part, and the first unit front part may include a second unit front part configured to be separable by the fourth cut line.

The window frame may include a first frame member on which the base member is mounted and extends in one direction; and a second frame member that extends in a direction intersecting the first frame member and on which the side member is mounted, and the side member may include a plurality of separable unit members, so as to have a variable shape according to a size of the second frame part.

The unit member may include a unit front part disposed on one surface of the window frame, and a unit side part formed by bending from the unit front part and disposed between the window frame and the side end part.

The window frame may further include a third frame member that extends in a direction intersecting with the second frame member and is located on the opposite side of the first frame member, and one end part of the unit front part is disposed to protrude further toward the third frame member than one end part of the unit side part.

The window frame may further include a third frame member that extends in a direction intersecting with the second frame member and is located on the opposite side of the first frame member, the side member may include a front part that is disposed on one surface of the window frame, and a side part that is formed by being bent from the front part and is disposed between the window frame and the side end part, and one end part of the front part may be disposed to protrude further toward the third frame member than one end part of the side part.

The window kit of an air conditioner may further include a first cover member covering a first area between one end of the base member and the first frame part; and a second cover member covering a second area between the other end of the base member and the rotation end part.

The first cover member may include a first coupling part coupled to the one end of the base member, a second coupling part coupled to the first frame part, and a first cover part formed of a flexible material and disposed between the first coupling part and the second coupling part.

The second cover member may include a third coupling part coupled to the other end of the base member, a fourth coupling part coupled to the rotation end part, and a second cover part formed of a flexible material and disposed between the third coupling part and the fourth coupling part.

The window frame may include a third frame member extending in a direction intersecting the second frame member, the third frame member being opposite the first frame member.

The window kit of an air conditioner may further include a third cover member covering a third area between the third frame member and the first end of the window.

The first cover part may be more flexible than the first coupling part and the second coupling part.

The window kit of an air condition may further include a finishing member covering an area between a side of the side member and the first side of the window.

The window kit of an air conditioner may further include at least one of an adhesive material configured to adhere the base member to the window frame and an adhesive material configured to adhere the side member to the first side of the window.

The following effects can be expected from the window kit of the air conditioner according to the proposed embodiment.

According to the window kit of the air conditioner according to an embodiment of the present disclosure, the exhaust guide member can be stably fixed to the hinged window through a structure that directly fixes the window kit to the window assembly.

The window kit of an air conditioner according to an embodiment of the present disclosure is configured to be adjustable in shape and size, so that it can be universally installed in window assemblies of various sizes.

According to the window kit of the air conditioner according to an embodiment of the present disclosure, by minimizing the open area in a hinged window assembly, it is possible to prevent air discharged to the outside through an exhaust guide member from being re-introduced into the room or cold air inside the room from being discharged to the outside.

According to the window kit of the air conditioner according to an embodiment of the present disclosure, the fixing means for fixing the window kit to the window is positioned in a location where it can be easily fixed indoors, so that the window kit can be easily fixed to the window assembly.

According to the window kit of the air conditioner according to an embodiment of the present disclosure, the window assembly can be fixed without being damaged, thereby preventing the aesthetics of an outer appearance of the window assembly from being deteriorated.

### BRIEF DESCRIPTION OF THE DRAWINGS

FIG. 1 is a perspective view illustrating a window kit of an air conditioner according to an embodiment equipped with an exhaust guide member of a mobile air conditioner.

FIG. 2 is a perspective view illustrating a window kit of an air conditioner according to an embodiment.

FIG. 3 is an exploded perspective view illustrating a window kit of an air conditioner according to an embodiment.

FIG. 4 is an enlarged view illustrating area A of FIG. 2.

FIG. 5 is a perspective view illustrating a side member of a window kit of an air conditioner according to an embodiment.

FIGS. 6 and 7 are perspective views illustrating a structure in which at least a portion of the side member is partially separated.

FIG. 8 is a schematic view illustrating the rear surface of the side member in an enlarged manner

FIG. 9 is a side view illustrating the side member.

FIG. 10 is a perspective cross-sectional view taken along line 10-10 of FIG. 9.

FIG. 11 is a cross-sectional view taken along line 11-11 of FIG. 9.

FIG. 12 is a front view illustrating the side member.

FIG. 13 is a cross-sectional view taken along line 13-13 of FIG. 12.

FIG. 14 is a cross-sectional view taken along line 14-14 of FIG. 1.

FIG. 15 is a schematic diagram illustrating area B of FIG. 14.

FIG. 16 is a schematic diagram illustrating area C of FIG. 14.

FIG. 17 is a cross-sectional view taken along line 17-17 of FIG. 1.

FIG. 18 is a perspective view illustrating a window assembly according to another embodiment.

FIG. 19 is a rear perspective view illustrating a side member according to another embodiment.

### DETAILED DESCRIPTION OF THE EMBODIMENTS

Hereinafter, specific embodiments of the present disclosure will be described in detail with reference to the drawings. However, the present disclosure is not limited to the embodiments in which the idea of the present disclosure is presented, and other regressive disclosures or other embodiments included within the scope of the idea of the present disclosure can be easily proposed by adding, changing, deleting, other components, or the like.

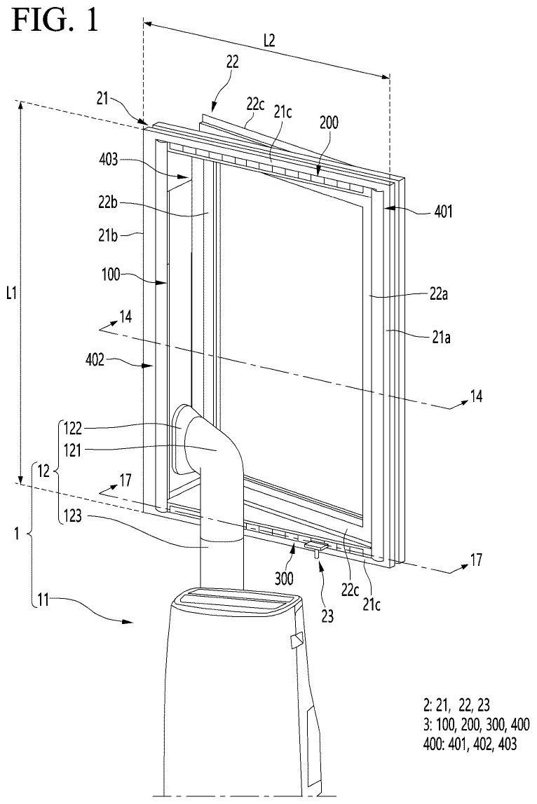

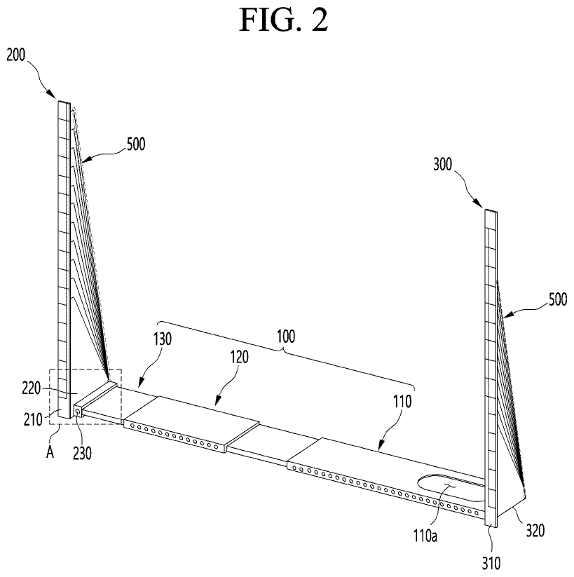

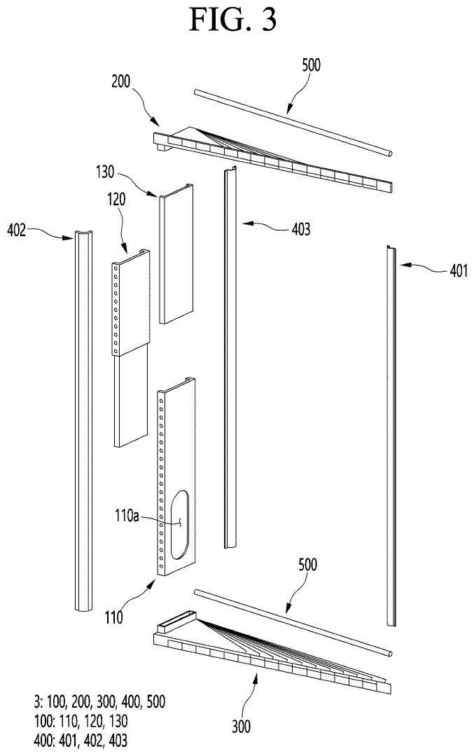

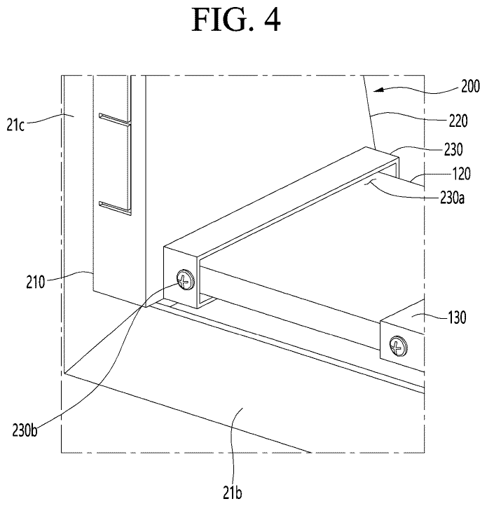

FIG. 1 is a perspective view illustrating a window kit of an air conditioner according to an embodiment equipped with an exhaust guide member of a mobile air conditioner, FIG. 2 is a perspective view illustrating a window kit of an air conditioner according to an embodiment, FIG. 3 is an exploded perspective view illustrating a window kit of an air conditioner according to an embodiment, and FIG. 4 is an enlarged view illustrating area A of FIG. 2.

Referring to FIGS. 1 to 4, an air conditioner 1 according to an embodiment may include a main body 11 and an exhaust guide member 12 configured to discharge air heat-exchanged from the main body 11 to the outside (particularly, outdoors).

As illustrated, the air conditioner 1 according to an embodiment is an integrated air conditioner in which an indoor device and an outdoor device are combined, and the indoor heat exchanger and the outdoor heat exchanger may be provided in one main body 11.

The main body 11 of the air conditioner 1 according to an embodiment may be configured to be moved to a required space. In other words, the air conditioner 1 according to an embodiment may be a mobile air conditioner that discharges heat-exchanged air to the outside through an exhaust guide member 12. The exhaust guide member 12 of the mobile air conditioner 1 may be fixed to a window assembly 2 for stable air discharge, and configured to discharge heat-exchanged air to the outside.

Components forming a refrigeration cycle may be built into the main body 11. For example, an evaporator, a heat exchanger that functions as a condenser, a compressor, an expansion device, and a fan motor for air flow may be built into the main body 11. A suction port for suctioning indoor air and a discharge port for discharging heat-exchanged air into the room may be formed in the main body 11. In addition, an exhaust port for discharging air to the outdoors may be formed in the main body 11, and an exhaust guide member 12 may be mounted on the exhaust port.

Air in an indoor space where the main body 11 is placed can be suctioned in through the suction port, heat-exchanged by a heat exchanger inside the main body 11, and then discharged into the indoor space through the discharge port. Other air that has passed through the heat exchanger and has been heat-exchanged can pass through the exhaust port and be discharged into the outdoor space by the exhaust guide member 12. The mobile air conditioner 1 can cool or heat an indoor space by this operation.

The exhaust guide member 12 can guide the flow of air exhausted from the main body 11 by connecting the exhaust port of the main body 11 and the window kit 3 installed on the window frame 21. For example, the exhaust guide member 12 can include an exhaust pipe 121 forming an air flow path, a nozzle 122 positioned at an end part of the exhaust pipe 121 and mounted on the window kit 3, and a main body connector 123 connecting the exhaust pipe 121 and the main body 11.

The exhaust pipe 121 may have a hollow tube shape. The exhaust pipe 121 may be flexible so as to be bent according to the position and height of the window assembly 2 to which the exhaust guide member 12 is connected. For example, the exhaust pipe 121 may be formed of a plastic that is flexible and can extend in length. The exhaust pipe 121 may be configured so that the inside maintains a circular shape even when bent as illustrated in FIG. 1.

The nozzle 122 can be mounted on the window kit 3. For example, the nozzle 122 can be mounted on the base member 100 described below. The nozzle 122 can be placed at one end part of the exhaust pipe 121. The nozzle 122 can discharge air discharged from the main body 11. In other words, the nozzle 122 fixes the exhaust guide member 12 to the window kit 3 so that the discharged air can be completely discharged to the outside. For example, the nozzle 122 can be formed of a plastic material.

A main body connector 123 may be provided between the main body 11 and the exhaust pipe 121. The main body connector 123 may allow the other end part of the exhaust pipe 121 to be mounted on the main body 11.

A window kit 3 of an air conditioner according to an embodiment may be provided to secure an exhaust guide member 12 to a window assembly 2. For example, a nozzle 122 of an exhaust guide member 12 may be mounted on the window kit 3 of the air conditioner.

The window assembly 2 may be formed as a hinged structure. The window assembly 2 may include a window frame 21 formed as an opening and a window 22 rotatably connected to the window frame 21 in a hinged manner. For example, the window 22 may be configured to open and close the opening of the window frame 21 by rotating around a rotation axis connected to the window frame 21. Although FIG. 1 illustrates a window 22 that rotates toward the outside relative to the window frame 21, the disclosure is not limited thereto and the window 22 may be configured to rotate toward the inside relative to the window frame 21.

The window 22 may be configured to open and close the opening of the window frame 21 by rotating. For example, the window 22 may include a fixed end part or a first end 22a disposed on the side of the rotation axis, a rotation end part or second end 22b positioned opposite the fixed end part 22a and moving along an arcuate trajectory when the window 22 is opened and closed, and a pair of side end parts 22c (a first side and a second side) connecting the fixed end part 22a and the rotation end part 22b. Here, the fixed end part 22a may constitute the rotation axis of the window 22, but is not limited thereto, and the fixed end part 22a may be disposed adjacent to the rotation axis of the window 22.

The window frame 21 may include a first frame part 21a (third frame member) corresponding to the fixed end part 22a, a second frame part 21b (first frame member) corresponding to the rotation end part 22b, and third frame parts 21c (second frame members) corresponding to the side end parts 22c. When the window 22 is closed, the first frame part 21a may be disposed opposite the fixed end part 22a, the second frame part 21b may be disposed opposite the rotation end part 22b, and the third frame parts 21c may be disposed opposite the side end parts 22c. The first frame part 21a, the second frame part 21b, and the third frame parts 21c may define an opening of the window frame 21.

Between the second frame part 21b and the rotation end part 22b, a base member 100 described later can be coupled. Between the third frame parts 21c and the side end parts 22c, side members 200, 300 described later can be fixed. The base member 100 and the side members 200, 300 can shield the space between the window frame 21 and the window 22 formed as the window 22 is opened.

The second frame part 21b may have a first length L1, and the third frame parts 21c may have a second length L2. In an embodiment, the window kit 3 of the air conditioner may be configured to be structurally changeable when the sizes of the second frame part 21b and the third frame parts 21c are changed.

The window assembly 2 may further include an opening member 23 configured to open and close the window 22 relative to the window frame 21. For example, the opening member 23 may be coupled to one of the third frame parts 21c. The opening member 23 may adjust the opening angle of the window 22 by rotating.

In this specification, the structure of a window 22 in which the first frame part 21a corresponding to the fixed end part 22a constitutes the right end part of the window frame 21 and the rotating end part 22b opens and closes to the outside has been described as a reference, but the embodiments of the present disclosure are not limited thereto and may be applied to a window 22 having a different type of hinged structure. For example, the embodiments of the present disclosure may be applied to a window assembly 2 having a hinged structure in which the window 22 rotates around the upper or lower end part of the window frame 21. In addition, the embodiments of the present disclosure may be applied to a structure of a window assembly 2 in which the window 22 opens and closes to the inside.

A window kit 3 of an air conditioner according to an embodiment may include a base member 100 positioned between a second frame part 21b and a rotation end part 22b, side members 200, 300 positioned between the third frame parts 21c and the side end parts 22c, and a cover member 400 that shields a gap formed between the respective components.

The base member 100 is fixed to the window frame 21 and the window 22 and can be connected to the exhaust guide member 12. For example, one end part of the base member 100 can be coupled to the second frame part 21b, and the other end part can be coupled to the rotation end part 22b of the window 22.

The base member 100 may include a plurality of panels 110, 120, 130. For example, the base member 100 may include a first panel 110 to which an exhaust guide member 12 is connected, a second panel 120 connected to the first panel 110 and configured to slide in and out in the longitudinal direction of the first panel 110, and a third panel 130 connected to the second panel 120 and configured to slide in and out in the longitudinal direction of the second panel 120. The base member 100 may be configured to have a variable length through the above structure. The length of the base member 100 may be variable according to the first length L1 of the second frame part 21b.

An opening 110a into which a nozzle 122 is inserted may be formed in the first panel 110. The opening 110a may be configured so that the nozzle 122 passes through it. For example, one end and the other end of the first panel 110 may be bent so that the second panel 120 can slide.

The side members 200, 300 can be coupled to one end and the other end of the base member 100. The side members 200, 300 can shield a space formed between the third frame parts 21c and the side end parts 22c. One end of the side members 200, 300 can be coupled to the third frame parts 21c, and the other end part can be coupled to the side end parts 22c of the window 22.

The side members 200, 300 may include a first side member 200 coupled to one end part of the base member 100 and a second side member 300 coupled to the other end part thereof. The first side member 200 and the second side member 300 may have a symmetrical structure with respect to each other. For example, the first side member 200 may be coupled to the third panel 130 of the base member 100, and the second side member 300 may be coupled to the first panel 110 of the base member 100.

The first side member 200 may include a front part or front portion 210, a side part or side portion 220 bent from the front part 210, and a coupling part or coupling portion 230 formed at a lower end part of the side part 220.

The front part 210 may be placed on the third frame parts 21c. The front part 210 may have a structure that extends in the extension direction of the third frame parts 21c. For example, the front part 210 may be placed on the front surface of a rib formed on the third frame parts 21c. The front part 210 may be formed to be partially separable.

The side part 220 can shield the space formed between the third frame parts 21c and the side end parts 22c. The side part 220 can have a shape corresponding to the area between the third frame parts 21c and the side end parts 22c. For example, the side part 220 can have a right triangle shape. The side part 220 can be formed to be partially separable.

The coupling part 230 may be formed on one surface of the side part 220. For example, the coupling part 230 may be formed at the lower end part of the side part 220 adjacent to the base member 100. One end part of the base member 100 may be coupled to the coupling part 230. The coupling part 230 may include a coupling groove 230a formed by being recessed toward the side part 220. One end part of the third panel 130 may be inserted into the coupling groove 230a formed in the coupling part 230 of the first side member 200. One end part of the third panel 130 inserted into the coupling groove 230a may be fixed to the coupling part 230 via a fastening member 230b.

The second side member 300 may include a front part 310, a side part 320 bent from the front part 310, and a coupling part 330 formed at a lower end part of the side part 320. The structures of the front part 310, the side part 320, and the coupling part 330 of the second side member 300 may be identical to the structures of the front part 210, the side part 220, and the coupling part 230 of the first side member 200, respectively.

The coupling part 330 may be formed on one surface of the side part 320. For example, the coupling part 330 may be formed at the lower end part of the side part 320 adjacent to the base member 100. One end part of the base member 100 may be coupled to the coupling part 330. The coupling part 330 may include a coupling groove 330a formed by being recessed toward the side part 320. One end part of the first panel 110 may be inserted into the coupling groove 330a formed in the coupling part 330 of the first side member 300. The one end part of the first panel 110 inserted into the coupling groove 330a may be fixed to the coupling part 330 via a fastening member 330b.

A window kit 3 of an air conditioner according to an embodiment may include a cover member 400 that shields a gap formed in a space between the window assembly 2 and the widow kit. The cover member 400 may include a first cover member 401 that shields a gap between a first frame part 21a of a window frame 21 and a fixed end part 22a of a window 22, a second cover member 402 that shields a gap between a base member 100 and a second frame part 21b of the window frame 21, and a third cover member 403 that shields a gap between the base member 100 and a rotation end part 22b of the window 22.

Meanwhile, the second cover member 402 can mutually couple the base member 100 and the second frame part 21b of the window frame 21. The third cover member 403 can mutually couple the base member 100 and the rotation end part 22b of the window 22.

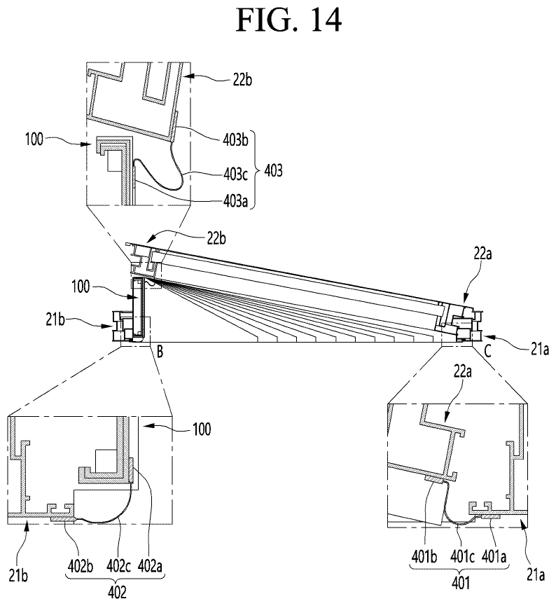

The first cover member 401 may have a shape extending along the extension direction of the first frame part 21a and the fixed end part 22a of the window 22. The second cover member 402 may have a shape extending along the extension direction of the base member 100 and the second frame part 21b. The third cover member 403 may have a shape extending along the extension direction of the base member 100 and the rotation end part 22b of the window 22. The coupling relationship between the window frame 21 and the window 22 through the cover member 400 will be described in detail with reference to FIGS. 14 to 17.

The window kit 3 of the air conditioner according to an embodiment may further include a finishing member 500 coupled to a side end of the side members 200, 300. The finishing member 500 may be coupled to a side end of the side members 200, 300 facing side end parts 22c of the window 22. When the side members 200, 300 is partially separated, the side end of the side members 200, 300 may have an uneven part having an irregular shape. The finishing member 500 may cover the side end of the side members 200, 300 facing the side end parts 22c to prevent exposure of the uneven part. The size and shape of the finishing member 500 may vary according to the size and shape of the side end of the side members 200, 300.

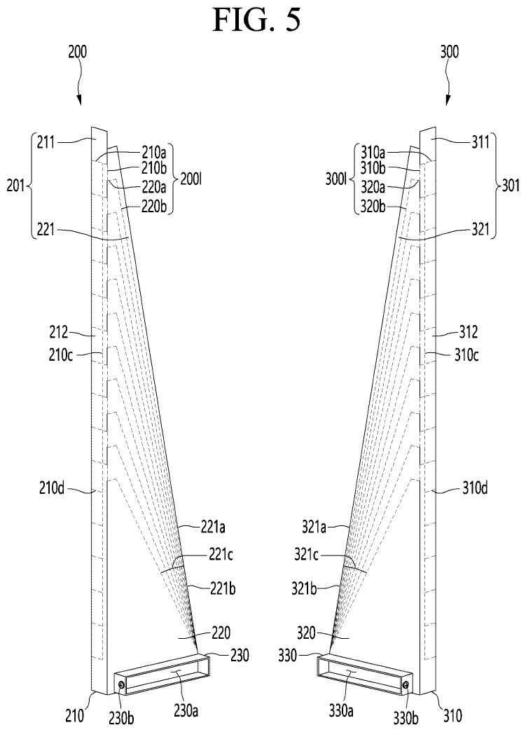

Hereinafter, the specific shapes of the side members 200, 300 will be described in detail with reference to FIGS. 5 to 13. In this specification, common contents regarding the side members 200, 300 are described based on the second side member 300. However, the description regarding the second side member 300 can be equally applied to the first side member 200.

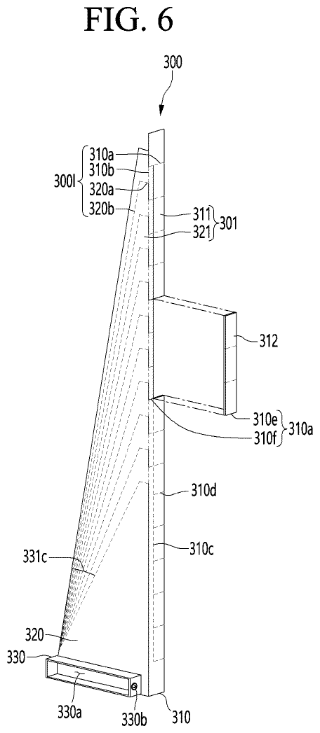

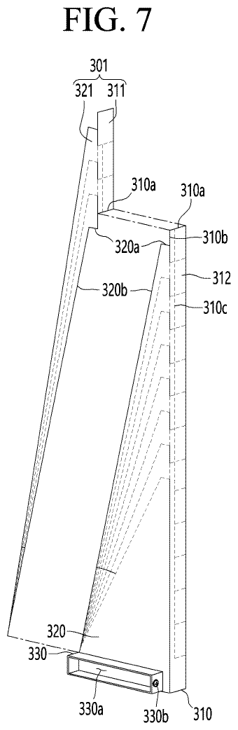

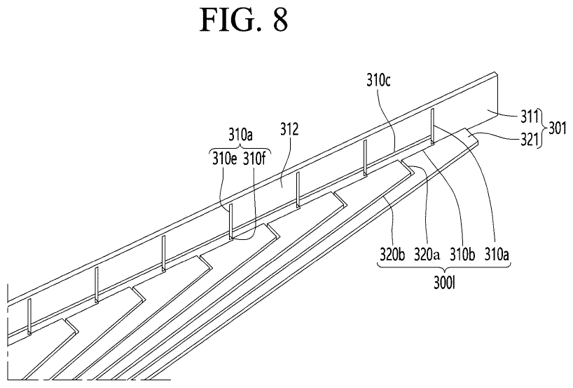

FIG. 5 is a perspective view illustrating a side member of a window kit of an air conditioner according to an embodiment, FIGS. 6 and 7 are perspective views illustrating a structure in which at least a portion of the side member is partially separated, and FIG. 8 is a schematic view illustrating the rear surface of the side member in an enlarged manner

Referring to FIGS. 5 to 8, side members 200, 300 according to an embodiment may include a first side member 200 and a second side member 300. The first side member 200 and the second side member 300 may be formed in a mutually symmetrical structure.

First, the first side member 200 will be described. As described above, the first side member 200 may include a front part 210, a side part 220 formed by bending from the front part 210, and a coupling part 230 formed on one surface of the side part 220.

One end part of the front part 210 may be formed to protrude further toward the first frame part 21a than one end part of the side part 220. In other words, the one end part of the front part 210 may be positioned closer to the first frame part 21a than one end part of the side part 220. Accordingly, the side part 220 may more airtightly shield the gap between the window frame 21 and the window 22.

The first side member 200 may include a plurality of unit members 201 configured to be separable. The unit member 201 may include a first unit front part 211 and a unit side part 221. The first unit front part 211 may be configured to be separable from the front part 210. The unit side part 221 may be configured to be separable from the side part 220. The first unit front part 211 and the unit side part 221 may be configured integrally. In other words, the integrated first unit front part 211 and the unit side part 221 may constitute the unit member 201.

The first side member 200 can be adjusted in size and shape by separating the unit member 201 according to the size and shape of the window assembly 2 to be installed. For example, the first side member 200 can be adjusted in size and shape by separating the unit member 201 according to the third frame parts 21c of the window frame 21 and the side end parts 22c of the window 22.

A plurality of first unit front parts 211 may be arranged in the extension direction of the front part 210. Each of the plurality of first unit front parts 211 may have the same size, but is not limited thereto and may have different sizes.

A plurality of unit side parts 221 may be arranged in the extension direction of the side part 220. Each of the plurality of unit side parts 221 may have a different shape. For example, the unit side part 221 may have a shape that is bent from one end part of the first unit front part 211 and extends downward in an inclined direction. The unit side part 221 may have a shape that becomes narrower as it goes downward.

In the first unit front part 211 and the unit side part 221 that constitute the unit member 201, one end part of the first unit front part 211 may be formed to protrude further toward the first frame part 21a than one end part of the unit side part 221. Accordingly, the side part 220 can more airtightly seal the gap between the window frame 21 and the window 22 even if the unit member 201 is separated and its size changes.

Each first unit front part 211 may include a second unit front part 212. The second unit front part 212 may be configured to be separable from the first unit front part 211. When the second unit front part 212 is separated from the first unit front part 211, an opening for the opening member 23 may be formed. In the window kit 3 of the air conditioner according to an embodiment, when the opening member 23 is positioned on the first side member 200, an opening for the open member 23 may be formed by separating the second unit front part 212 from the first unit front part 211.

The first side member 200 may include a cut part 2001 to facilitate separation of the unit member 201. The cut part 2001 may be configured in a groove or hole shape to facilitate separation. For example, the cut part 2001 may include a first front cut line 210a disposed between adjacent first unit front parts 211, a second front cut line 210b disposed between the front part 210 and the side part 220, and a first side cut line 220a and a second side cut line 220b disposed between adjacent unit side parts 221.

The first front cut line 210a may be positioned between adjacent first unit front parts 211 to facilitate separation of the first unit front parts 211. For example, the first front cut line 210a may extend in a direction from the front part 210 toward the side part 220.

The second front cut line 210b may be disposed between the front part 210 and the side part 220. The second front cut line 210b may be connected to the first front cut line 210a. The second front cut line 210b may be formed by extending downward from one end part of the first front cut line 210a. The second front cut line 210b may be provided to separate the front part 210 and the side part 220. On one side and the other side of the second front cut line 210b, a first unit front part 211 and a unit side part 221 included in different unit members 201 may be disposed.

The first side cut line 220a and the second side cut line 220b are disposed between adjacent unit side parts 221, so as to facilitate separation of the unit side parts 221. The first side cut line 220a can be connected to the second front cut line 210b. The first side cut line 220a can extend laterally from a lower end part of the second front cut line 210b. The second side cut line 220b can extend downward from one end part of the first side cut line 220a.

The size of the unit side part 221 can be changed according to the spacing between the plurality of first side cut lines 220a arranged in one direction. The spacing between the plurality of second side cut lines 220b arranged in one direction can be reduced toward the lower side.

The unit side part 221 may include a first part 221a positioned above the side boundary part 221c and a second part 221b positioned below the side boundary part. As will be described later, the thickness of the second part 221b may be formed smaller than the thickness of the first part 221a. Through the above structure, even if the spacing between the second side cut lines 220b in the second part 221b is narrowed, the unit side part 221 may be easily separated.

A third front cut line 210c and a fourth front cut line 210d can be formed on the front part 210.

The third front cut line 210c may extend in the extension direction of the front part 210. For example, the third front cut line 210c may have a shape extending in the vertical direction. The third front cut line 210c may be formed to easily separate the second unit front part 212.

The fourth front cut line 210d may be located below the first front cut line 210a. The fourth front cut line 210d may extend part in a direction parallel to the first front cut line 210a. For example, the fourth front cut line 210d may be formed in an area where the second front cut line 210b is not formed to separate the second unit front part 212.

In other words, the second unit front part 212 can be easily separated through the first front cut line 210a, the third front cut line 210c, and the fourth front cut line 210d.

Hereinafter, the second side member 300 will be described. The second side member 300 may have a structure that is symmetrical to the first side member 200 described above.

The second side member 300 may include a front part 310, a side part 320 formed by being bent from the front part 310, and a coupling part 330 formed on one surface of the side part 320. One end part of the front part 310 may be formed to protrude further toward the first frame part 21a than one end part of the side part 320. The one end part of the front part 310 may be disposed adjacent to the first frame part 21a. Therefore, the side part 320 may more airtightly shield the gap between the window frame 21 and the window 22.

The second side member 300 may include a plurality of unit members 301 configured to be separable. The unit member 301 may include a first unit front part 311 and a unit side part 321. The first unit front part 311 may be configured to be separable from the front part 310. The unit side part 321 may be configured to be separable from the side part 320. The first unit front part 311 and the unit side part 321 may be configured integrally. In other words, the integrated first unit front part 311 and the unit side part 321 may constitute the unit member 301.

The second side member 300 can be adjusted in size by separating the unit member 301 according to the size of the window frame 21 and window 22 to be installed. For example, the second side member 300 can be adjusted in size by separating the unit member 301 according to the size of the third frame parts 21c of the window frame 21 and the size of the side end parts 22c of the window 22.

A plurality of first unit front parts 311 may be arranged in the extension direction of the front part 310. Each of the plurality of first unit front parts 311 may have the same size, but is not limited thereto and may have different sizes.

The plurality of unit side parts 321 may be arranged in the extension direction of the side part 320. Each of the plurality of unit side parts 321 may have a different shape. For example, the unit side part 321 may have a shape that is bent from one end part of the first unit front part 311 and extends downward in an inclined direction. The unit side part 321 may have a shape that becomes narrower as it goes downward.

In the first unit front part 311 and the unit side part 321 that constitute the unit member 301, one end part of the first unit front part 311 may be formed to protrude further toward the first frame part 21a than one end part of the unit side part 321. Accordingly, the side part 320 can more airtightly seal the gap between the window frame 21 and the window 22 even if the unit member 301 is separated and its size changes.

Each first unit front part 311 may include a second unit front part 312. The second unit front part 312 may be configured to be separable from the first unit front part 311. When the second unit front part 312 is separated from the first unit front part 311, an opening for the opening member 23 may be formed. When the opening member 23 is mounted on a window frame 21 or window 22 to which the second side member 300 is coupled, an opening for the opening member 23 may be formed by separating the second unit front part 312 from the first unit front part 311.

The second side member 300 may include a cut part 3001 to facilitate separation of the unit member 301. The cut part 3001 may be configured in a groove g or hole h shape to facilitate separation. For example, the cut part 3001 may include a first front cut line 310a disposed between adjacent first unit front parts 311, a second front cut line 310b disposed between the front part 310 and the side part 320, and a first side cut line 320a and a second side cut line 320b disposed between adjacent unit side parts 321.

The first front cut line 310a may be positioned between adjacent first unit front parts 311 to facilitate separation of the first unit front parts 311. For example, the first front cut line 310a may extend in a direction from the front part 310 toward the side part 320.

The second front cut line 310b may be disposed between the front part 310 and the side part 320. The second front cut line 310b may be connected to the first front cut line 310a. The second front cut line 310b may be formed by extending downward from one end part of the first front cut line 310a. The second front cut line 310b may be provided to separate the front part 310 and the side part 320. On one side and the other side of the second front cut line 310b, a first unit front part 311 and a unit side part 321 included in different unit members 301 may be disposed.

The first side cut line 320a and the second side cut line 320b are disposed between adjacent unit side parts 321, so as to facilitate separation of the unit side parts 321. The first side cut line 320a can be connected to the second front cut line 310b. The first side cut line 320a can extend part laterally from a lower end part of the second front cut line 310b. The second side cut line 320b can extend part downward from one end part of the first side cut line 320a.

The spacing between the plurality of first side cut lines 320a arranged in one direction can be changed according to the size of the unit side part 321. The spacing between the plurality of second side cut lines 320b arranged in one direction can be reduced toward the lower side.

The unit side part 321 may include a first part 321a positioned above the side boundary part 321c and a second part 321b positioned below. As will be described later, the thickness of the second part 321b may be formed smaller than the thickness of the first part 321a. Through the above structure, even if the spacing of the second side cut lines 320b decreases toward the lower side, the unit side part 321 can be easily separated.

A third front cut line 310c and a fourth front cut line 310d can be formed on the front part 310.

The third front cut line 310c may extend part in the extension direction of the front part 310. For example, the third front cut line 310c may have a shape extending in the vertical direction. The third front cut line 310c may be formed to easily separate the second unit front part 312.

The fourth front cut line 310d may be located below the first front cut line 310a. The fourth front cut line 310d may extend part in a direction parallel to the first front cut line 310a. For example, the fourth front cut line 310d may be formed in an area where the second front cut line 310b is not formed to separate the second unit front part 312.

In other words, the second unit front part 312 can be easily separated through the first front cut line 310a, the third front cut line 310c, and the fourth front cut line 310d.

The first front cut line 310a may include a first sub-cut line 310e disposed on one side with respect to the third front cut line 310c and a second sub-cut line 310f disposed on the other side. In other words, the first front cut line 310a may be divided into a first sub-cut line 310e and a second sub-cut line 310f with respect to the third front cut line 310c. The first sub-cut line 310e may form one side of the second unit front part 312. For example, the first sub-cut line 310e may be formed longer than the second sub-cut line 310f.

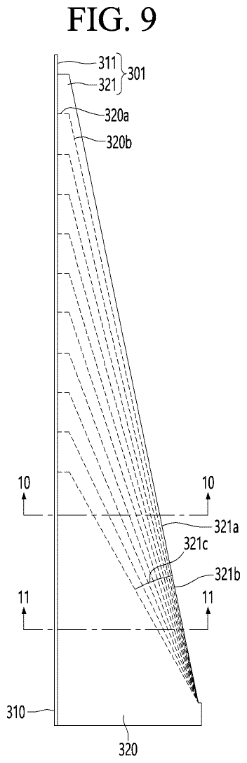

Below, the structure of the cut part 3001 will be described with reference to FIGS. 9 to 13.

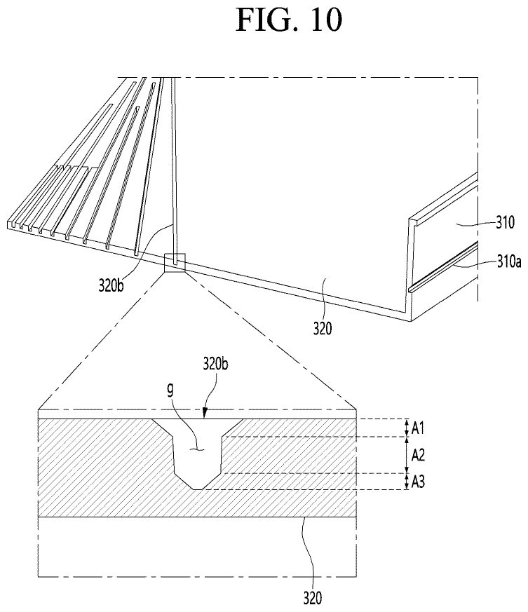

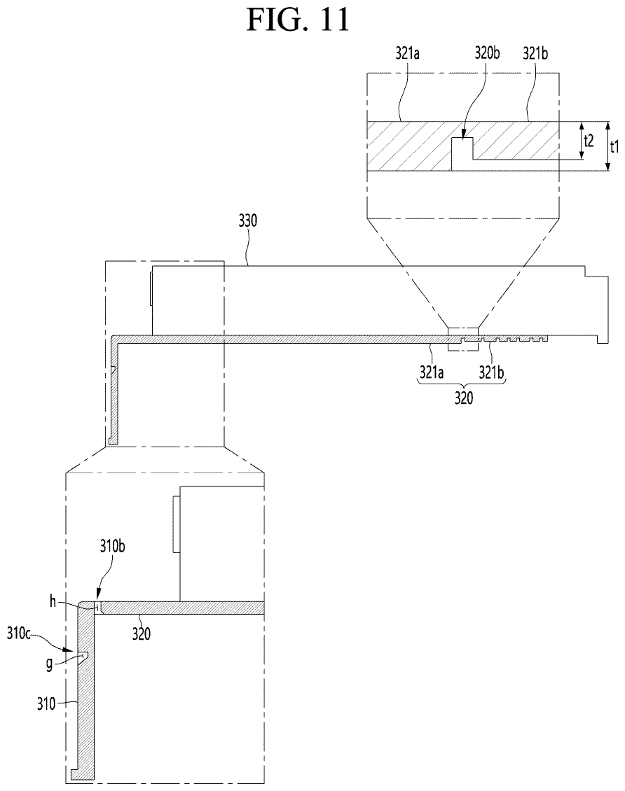

FIG. 9 is a side view illustrating the side member, FIG. 10 is a perspective cross-sectional view taken along line 10-10 of FIG. 9, and FIG. 11 is a cross-sectional view taken along line 11-11 of FIG. 9.

Referring to FIGS. 9 to 11, the second side cut line 320b may have a groove g structure in a recessed groove shape. The second side cut line 320b may be configured to enable precise separation through the groove g structure.

The side part 320 on which the second side cut line 320b is formed may have different widths according to the thickness. For example, the second side cut line 320b may include first to third regions A1, A2, A3 according to the recessed depth. The recessed depth of the second side cut line 320b may become deeper as it goes from the first region A1 to the third region A3.

The width of the first region A1 of the second side cut line 320b may be greater than the width of the second region A2. The width of the second region A2 of the second side cut line 320b may be greater than the width of the third region A3. The width of the first region A1 of the second side cut line 320b may become smaller as it goes toward the second region A2. The width of the third region A3 of the second side cut line 320b may become smaller as it goes away from the second region A2. The width of the second region A2 of the second side cut line 320b may be generally constant.

The second front cut line 310b may have a hole h structure defining an opening. Since the second front cut line 310b is formed between the front part 310 and the side part 320, it can be configured to be separated with little force through the hole h structure.

The third front cut line 310c may have a groove g structure in the groove shape. The groove g of the third front cut line 310c may be defined by a first surface positioned close to the side part 320 and a second surface positioned farther from the side part 320. The first surface of the groove g of the third front cut line 310c may extend in the thickness direction of the front part 310, and the second surface may be formed to be inclined so as to become closer to the first surface as it increases in the thickness direction of the front part 310.

Through the above structure, even when the second unit front part 312 is separated along the third front cut line 310c, the front part 310 can form a clean outer appearance.

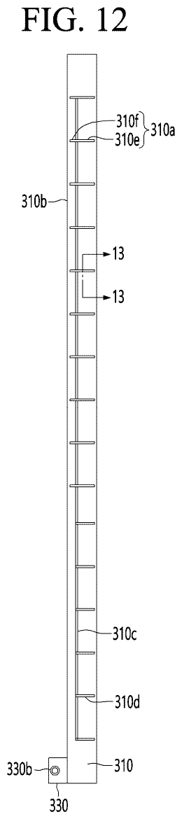

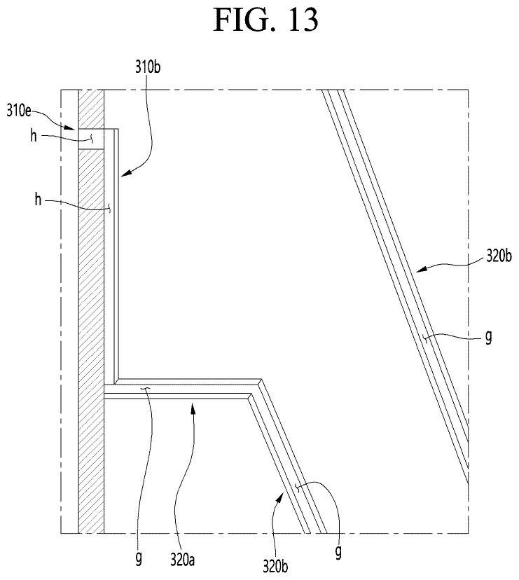

FIG. 12 is a front view illustrating the side member, and FIG. 13 is a sectional view taken along line 13-13 of FIG. 12.

Referring to FIGS. 12 and 13, the first front cut line 310a may have a hole h structure formed by being opened. Since a plurality of the first front cut lines 310a are formed in a narrow area, it can be configured to be precisely separated through the hole h structure.

Meanwhile, the first side cut line 320a may have substantially the same cross-sectional structure as the second side cut line 320b described above. For example, the first side cut line 320a may have a groove g structure in the shape of a recessed groove. The first side cut line 320a may be configured to enable precise separation through the groove g structure.

The first part 321a may have a first thickness t1, and the second part 321b may be formed to have a second thickness t2 smaller than the first thickness t1. Through the above structure, even if the spacing between the second side cut lines 320b in the second part 321b becomes narrow, the unit side parts 321 may be easily separated.

The fourth front cut line 310d may be formed with a structure similar to the first front cut line 310a. In other words, the fourth front cut line 310d may have a hole structure formed by being opened. Since a plurality of fourth front cut lines 310d are formed in a narrow area, it may be configured to be precisely separated through the hole h structure.

Referring to FIGS. 14 to 17, a shielding structure through a cover member 400 is described.

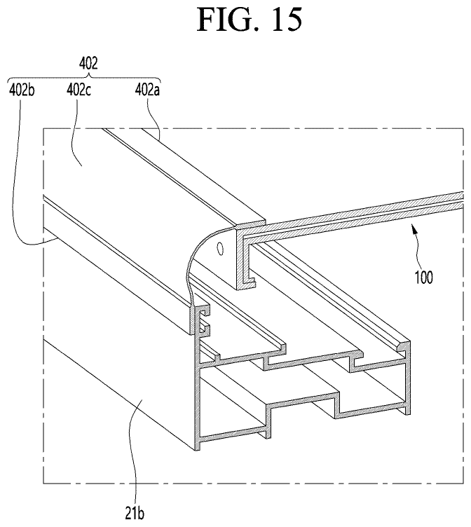

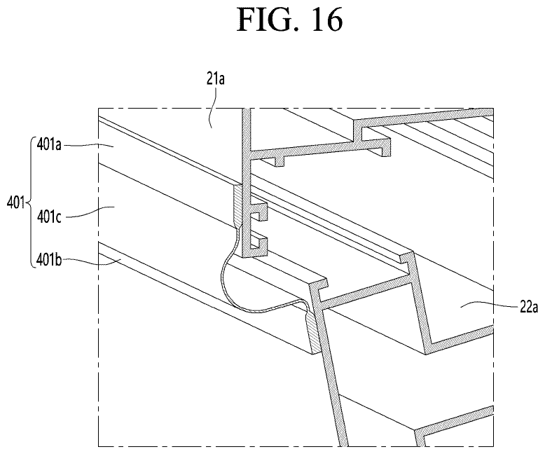

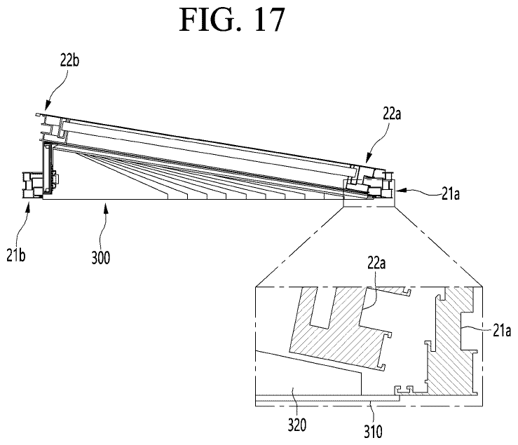

FIG. 14 is a cross-sectional view taken along line 14-14 of FIG. 1, FIG. 15 is a schematic diagram illustrating area B of FIG. 14, FIG. 16 is a schematic diagram illustrating area C of FIG. 14, and FIG. 17 is a cross-sectional view taken along line 17-17 of FIG. 1.

First, referring to FIGS. 14 to 16, a window kit 3 of an air conditioner according to an embodiment may include a cover member 400 that shields a gap formed in a space between the window assembly 2 and the window kit 3. The cover member 400 may include a first cover member 401 that shields a gap between a first frame part 21a of a window frame 21 and a fixed end part 22a of a window 22, a second cover member 402 that shields a gap between a base member 100 and a second frame part 21b of the window frame 21, and a third cover member 403 that shields a gap between the base member 100 and a rotation end part 22b of the window 22.

The first cover member 401 may have a shape that extends along the extension direction of the first frame member 21a and the fixed end part 22a of the window 22. The second cover member 402 may have a shape that extends along the extension direction of the base member 100 and the second frame part 21b. The third cover member 403 may have a shape that extends along the extension direction of the base member 100 and the rotation end part 22b of the window 22.

The first cover member 401 may include a first coupling part 401a coupled to a first frame member 21a of a window frame 21, a second coupling part 401b coupled to a fixed end part 22a of a window 22, and a cover member 401c disposed between the first coupling part 401a and the second coupling part 401b.

The first coupling part 401a can be attached to the first frame part 21a of the window frame 21. For example, the first coupling part 401a can be attached to the first frame part 21a via an adhesive member. The first coupling part 401a can extend along the extension direction of the first frame part 21a.

The second coupling part 401b can be attached to the fixed end part 22a of the window 22. For example, the second coupling part 401b can be attached to the fixed end part 22a via an adhesive member. The second coupling part 401b can extend along the extension direction of the fixed end part 22a.

The cover part 401c may have one end connected to the first coupling part 401a and the other end connected to the second coupling part 401b. The cover part 401c may stably shield the gap between the window frame 21 and the window 22. For example, the cover part 401c may be composed of a flexible film material. The cover part 401c may be more flexible than the first coupling part 401a and the second coupling part 401b.

The second cover member 402 may include a first coupling part 402a coupled to the base member 100, a second coupling part 402b coupled to the second frame part 21b of the window frame 21, and a cover part 402c disposed between the first coupling part 402a and the second coupling part 402b.

The first coupling part 402a may be attached to the base member 100. For example, the first coupling part 402a may be attached to the front end of the base member 100 via an adhesive member. The first coupling part 402a may extend part along the extension direction of the base member 100.

The second coupling part 402b can be attached to the second frame part 21b of the window frame 21. For example, the second coupling part 402b can be attached to the second frame part 21b via an adhesive member. The second coupling part 402b can extend along the extension direction of the second frame part 21b.

The cover part 402c may have one end connected to the first coupling part 402a and the other end connected to the second coupling part 402b. The cover part 402c may stably shield the gap between the second frame part 21b of the window frame 21 and the base member 100. For example, the cover part 402c may be composed of a flexible film material.

Through the above structure, the second cover member 402 can mutually couple the base member 100 and the second frame part 21b of the window frame 21.

The third cover member 403 may include a first coupling part 403a coupled to the base member 100, a second coupling part 403b coupled to the rotation end part 22b of the window 22, and a cover member 403c disposed between the first coupling part 403a and the second coupling part 403b.

The first coupling part 403a may be attached to the base member 100. For example, the first coupling part 403a may be attached to the rear end of the base member 100 via an adhesive member. The first coupling part 403a may extend along the extension direction of the base member 100.

The second coupling part 403b can be attached to the rotation end part 22b of the window 22. For example, the second coupling part 403b can be attached to the rotation end part 22b of the window 22 through an adhesive member. The second coupling part 403b can extend along the extension direction of the rotation end part 22b of the window 22.

The cover part 403c can have one end connected to the first coupling part 403a and the other end connected to the second coupling part 403b. The cover part 403c can stably shield the gap between the rotating end part 22b of the window 22 and the base member 100. For example, the cover part 403c can be composed of a flexible film material.

Through the above structure, the third cover member 403 can mutually couple the base member 100 and the rotation end part 22b of the window 22.

Meanwhile, the cover member 400 may be formed by placing an adhesive member on one end and the other end of a flexible film.

Referring to FIG. 17, one end part of the front part 310 of the second side member 300 can be in contact with the first frame part 21a of the window frame 21. For example, one end part of the front part 310 of the second side member 300 that is disposed toward the first frame part 21a can be in contact with one surface of the first frame part 21a. Since the one end part of the front part 310 of the second side member 300 is formed to protrude to one side more than one end part of the side part 320, the gap between the first frame part 21a and the fixed end part 22a of the window 22 can be stably shielded. Through the above structure, the second side member 300 can further block the inflow of outside air and the outflow of inside air.

The above contents can be equally applied to the front part 210 of the first side member 200. In other words, one end part of the front part 210 of the first side member 200 can be in contact with one surface of the first frame part 21a of the window frame 21.

According to the window kit of the air conditioner according to an embodiment of the present disclosure, the exhaust guide member can be stably fixed to the hinged window through a structure that directly fixes the window kit to the window frame.

According to the window kit of the air conditioner according to an embodiment of the present disclosure, the size is configured to be adjustable, so that it can be installed in hinged windows of various sizes, regardless of the size of the hinged window.

According to a window kit 3 of an air conditioner according to an embodiment, by having a structure capable of completely shielding a gap area in a window assembly 2, the open area can be minimized, thereby preventing air discharged to the outside through an exhaust guide member 12 from being re-introduced into the room or cold air inside the room from being leaked out to the outside.

According to the window kit 3 of the air conditioner according to an embodiment, the fixing means for fixing the window kit 3 to the window assembly 2 is located in a place that is easily accessible indoors, so that the window kit 3 can be easily fixed to the window assembly 2.

According to the window kit 3 of the air conditioner according to an embodiment, the window kit 3 can be fixed to the window frame 21 without damaging the window frame 21, thereby preventing the aesthetics of an outer appearance of the window frame 21 from being deteriorated.

Meanwhile, the present disclosure may have various other embodiments in addition to the above-described embodiments. Hereinafter, other embodiments of the present disclosure will be described with reference to the drawings. Among the configurations of other embodiments of the present disclosure, the same configurations as the above-described embodiments may be omitted for detailed description and illustration, and may be described using the same drawing reference numerals. In other words, only the structures that are different from the above-described embodiments will be described below, and other configurations that are not described may be the same as the above-described embodiments.

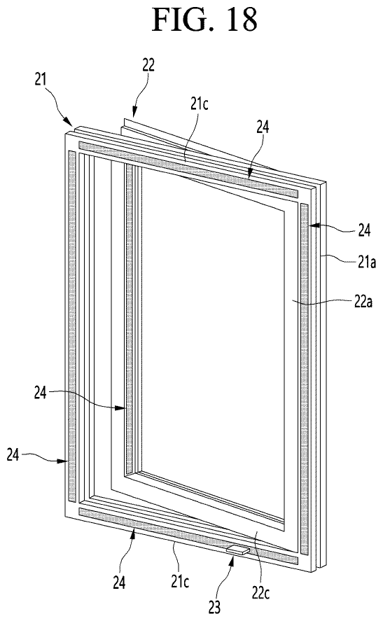

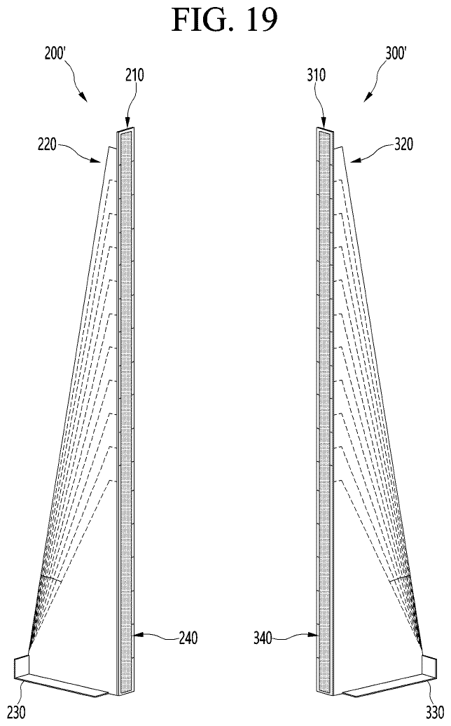

FIG. 18 is a perspective view illustrating a window assembly according to another embodiment, and FIG. 19 is a rear perspective view illustrating a side member according to another embodiment.

Referring to FIGS. 18 and 19, the window assembly 2 according to an embodiment may further include a first adhesive part or first adhesive member 24. The first adhesive part 24 may be provided to secure the window kit 3 for an air conditioner to the window frame 21 and the window 22.

The first adhesive part 24 may be provided on at least one of the first frame part 21a, the second frame part 21b, and the third frame parts 21c of the window frame 21. For example, the first coupling part 401a of the first cover member 401 may be attached to the first adhesive part 24 provided on the first frame part 21a. The second coupling part 402b of the second cover member 402 may be attached to the first adhesive part 24 provided on the second frame part 21b. The side members 200, 300 may be attached to the first adhesive part 24 provided on the third frame parts 21c.

In addition, the first adhesive part 24 may be provided at the rotation end part 22b of the window 22. For example, the second coupling part 403b of the third cover member 403 may be attached to the first adhesive part 24 provided at the rotation end part 22b of the window 22.

Meanwhile, the side members 200, 300 according to an embodiment may further include second and third adhesive parts or second and third adhesive members 240, 340. The first side member 200 may include the second adhesive part 240, and the second side member 300 may include the third adhesive part 340.

The second adhesive part 240 may be placed on the rear surface of the front part 210 of the first side member 200. The second adhesive part 240 may be attached to the first adhesive part 24 provided on the third frame parts 21c of the window frame 21, thereby firmly fixing the first side member 200 to the third frame parts 21c of the window frame 21.

The third adhesive part 340 may be placed on the rear surface of the front part 310 of the second side member 300. The third adhesive part 340 may be attached to the first adhesive part 24 provided on the third frame parts 21c of the window frame 21, thereby firmly fixing the second side member 300 to the third frame parts 21c of the window frame 21.

The first adhesive part 24, the second adhesive part 240, and the third adhesive part 340 may be composed of Velcro members. For example, the first adhesive part 24 and the second adhesive part 240 may be composed of mutually attachable Velcro members. In addition, the first adhesive part 24 and the third adhesive part 340 may be composed of mutually attachable Velcro members.

The window kit 3 of the air conditioner according to the present embodiment can secure the side members 200, 300 to the window frame 21 through the first adhesive part 24, the second adhesive part 240, and the third adhesive part 340. Therefore, the side members 200, 300 can be firmly secured to the window frame 21 without damaging the window frame 21.

### INDUSTRIAL APPLICABILITY

According to the window kit of the air conditioner according to an embodiment of the present disclosure, the exhaust guide member can be stably fixed to the hinged window through a structure in which the window kit is directly fixed to the window assembly, and thus, the industrial applicability is recognized.

The window kit of an air conditioner according to an embodiment of the present disclosure is configured to be adjustable in shape and size, and thus can be universally installed in window assemblies of various sizes, and thus its industrial applicability is recognized.

According to the window kit of an air conditioner according to an embodiment of the present disclosure, by minimizing the open area in a hinged window assembly, air discharged to the outside through an exhaust guide member can be prevented from being re-introduced into the room or cold air inside the room from being discharged to the outside, and thus, industrial applicability is recognized.

According to the window kit of the air conditioner according to an embodiment of the present disclosure, the fixing means for fixing the window kit to the window is located in a place where it can be easily fixed indoors, so that the window kit can be easily fixed to the window assembly, and thus the industrial applicability is recognized.

According to the window kit of an air conditioner according to an embodiment of the present disclosure, the window assembly can be fixed without being damaged, thereby preventing the aesthetics of the outer appearance of the window assembly from being deteriorated, and thus its industrial applicability is recognized.

What is claimed is:

1. A window kit configured to connect a mobile air conditioner to a window frame to which a window is connected, the window having a first end hingedly attached to the window frame, a second end located opposite to the first end, and a first side and a second side each extending between the first end and the second end, the window kit comprising:
a side member configured to be disposed between the window frame and the first side of the window; and
a base member configured to be disposed between the window frame and the second end of the window, the base member including an opening configured to accommodate a nozzle extending from an exhaust port of the mobile air conditioner, a first end of the base member being configured to be coupled to the side member.

2. The window kit of claim 1, wherein the base member includes a plurality of panels slidably connected to each other to adjust a length of the base member.

3. The window kit of claim 1, wherein the side member includes:
a front portion configured to be disposed on one surface of the window frame;
a side portion extending from the front portion, the side portion being configured to be disposed between the window frame and the first side of the window; and
a coupling portion located at a first surface of the side portion, the coupling portion being configured to be coupled to the first end of the base member.

4. The window kit of claim 3, wherein the coupling portion includes a coupling groove, and
wherein the first end of the base member is configured to be inserted into the coupling groove.

5. The window kit of claim 4, further comprising a fastening member configured to extend through the coupling portion into the first end of the base member to fix the base member to the side member.

6. The window kit of claim 4, wherein the coupling portion is located at a first end of the side portion, and
wherein a second end of the front portion extends beyond a second end of the side portion.

7. The window kit of claim 4, wherein the side member includes a plurality of separable unit members, and
wherein a shape of the side member is configured to be adjusted by removing one or more of the separable unit members.

8. The window kit of claim 7, wherein each separable unit member includes:
a first unit front part defining a portion of the front portion, and
a unit side part defining a portion of the side portion.

9. The window kit of claim 8, wherein the side member includes a plurality of cut portions, each cut portion being located between adjacent separable unit members for separation of the separable unit members, each cut portion including:
a first cut line located in the front portion; and
a second cut line located in the side portion.

10. The window kit of claim 9, wherein each cut portion further includes a third cut line extending between the front portion and the side portion, the third cut line connecting the first cut line and the second cut line.

11. The window kit of claim 10, further comprising a plurality of fourth cut lines, each fourth cut line being located in the front portion, each fourth cut line intersecting adjacent first cut lines to define a second unit front part configured to be separable from the front portion.

12. The window kit of claim 9, wherein each first cut line is an open hole, and wherein each second cut line is a recessed groove.

13. The window kit of claim 1, wherein the window frame includes:
a first frame member facing the base member, the first frame member extending in a first direction; and
a second frame member extending in a direction intersecting the first frame member, the second frame member facing the side member, and
wherein the side member includes a plurality of separable unit members, and
wherein a shape of the side member is configured to be adjusted by removing one or more of the separable unit members to fit a space between the second frame member and the first side of the window.

14. The window kit of claim 13, wherein each separable unit member includes:
a unit front part configured to be disposed on one surface of the first frame member, and
a unit side part extending from the unit front part, the unit side part being configured to be disposed between the second frame member and the first side of the window.

15. The window kit of claim 14, wherein the window frame further includes a third frame member extending in a direction intersecting the second frame member, the third frame member being opposite the first frame member, and
wherein one end portion of the unit front part is configured to protrude further toward the third frame member than one end portion of the unit side part is configured to protrude toward the third frame member.

16. The window kit of claim 13, wherein the window frame further includes a third frame member extending in a direction intersecting the second frame member, the third frame member being opposite the first frame member,
wherein the side member includes:
a front portion being configured to be disposed on one surface of the first frame member, and
a side portion extending from the front portion, the side portion being configured to be disposed between the second frame member and the first side of the window, and
wherein one end portion of the front portion is configured to protrude further toward the third frame member than one end portion of the side portion is configured to protrude toward the third frame member.

17. The window kit of claim 13, further comprising:
a first cover member configured to cover a first area between a first side of the base member and the first frame member; and
a second cover member configured to cover a second area between a second side of the base member and the second end of the window.

18. The window kit of claim 17, wherein the first cover member includes:
a first coupling part configured to be coupled to the first side of the base member;
a second coupling part configured to be coupled to the first frame member; and
a first cover part extending between the first coupling part and the second coupling part, and
wherein the second cover member includes:
a third coupling part configured to be coupled to the second side of the base member;
a fourth coupling part configured to be coupled to the second end of the window, and
a second cover part extending between the third coupling part and the fourth coupling part.

19. The window kit of claim 18, wherein the window frame further includes a third frame member extending in a direction intersecting the second frame member, the third frame member being opposite the first frame member, and
wherein the window kit further comprises a third cover member configured to cover a third area between the third frame member and the first end of the window.

20. The window kit of claim 18, wherein the first cover part is more flexible than the first coupling part and the second coupling part.

21. The window kit of claim 13, further comprising a finishing member configured to cover an area between a side of the side member and the first side of the window.

22. The window kit of claim 1, further comprising at least one of an adhesive material configured to adhere the base member to the window frame and an adhesive material configured to adhere the side member to the first side of the window.
